(19) United States
(12) Patent Application Publication
(10) Pub. No.: US 2019/0263670 A1
(43) Pub. Date: Aug. 29, 2019

(54) METHOD AND APPARATUS FOR PRODUCING CARBONATE

(71) Applicant: RESEARCH INSTITUTE OF INDUSTRIAL SCIENCE & TECHNOLOGY, Pohang-si (KR)

(72) Inventors: Woo Chul JUNG, Pohang-si (KR); Sang Gil LEE, Pohang-si (KR); Kwang Seok PARK, Pohang-si (KR); Sung Kook PARK, Pohang-si (KR); Ki Young KIM, Pohang-si (KR); Jin Yeop WI, Pohang-si (KR); Hyun Woo LEE, Pohang-si (KR); Woon Kyoung PARK, Pohang-si (KR); Myung Gyu LEE, Daejeon (KR)

(21) Appl. No.: 16/308,075

(22) PCT Filed: Jun. 7, 2016
(86) PCT No.: PCT/KR2016/005993

§ 371 Date: Dec. 7, 2018

(51) Int. Cl. C01D 15/08; C01B 32/60; B01J 10/00; B01J 19/26

(52) U.S. Cl. CPC C01D 15/08; C01B 32/60; C01P 2002/72; B01J 19/26; B01J 10/00

(57) ABSTRACT

An apparatus for preparing carbonate according to an embodiment of the present invention includes a reactor in which carbonation gas reacts with a solution to be carbonated; a first nozzle located at one side of the reactor, and discharging the solution to be carbonated into the reactor, a second nozzle located adjacent to the first nozzle, and spraying the carbonation gas into the path through which the solution to be carbonated is discharged to form a mist composed of the solution to be carbonated and the carbonation gas, and a recovery unit located at a lower end of the reactor, and recovering a carbonate salt from the slurry formed in the reactor.

### TECHNICAL FIELD

An apparatus for preparing carbonate and a method for preparing the same are disclosed.

### PRIOR ART

The production process of lithium carbonate (Li₂CO₃) using carbonation gas (ex, carbon dioxide gas, CO₂) uses a facility equipped with a reaction tank for the reaction of lithium hydroxide (LiOH) with carbon dioxide gas. The lithium hydroxide aqueous solution is a basic solution. The carbon dioxide gas is dissolved in an aqueous solution of lithium hydroxide to convert lithium hydroxide to lithium carbonate. This method should be controlled to maintain the base solution so that the carbonation gas is easily dissolved, and to prevent the carbonation gas from becoming in an excessively dissolved state.

When the lithium hydroxide aqueous solution is in a strong base state, the carbonation gas dissolves very quickly, thereby causing a reaction with lithium carbonate. This reaction uses a method of bubbling carbonation gas into the lithium hydroxide aqueous solution in the tank. At this time, since the reaction of the carbonation is the fastest in the vicinity of the nozzle for bubbling carbonation gas, there is a problem of nozzle clogging due to the reacted lithium carbonate.

In order to solve this problem, conventionally, a pressurizing tank is prepared. A lithium hydroxide aqueous solution is filled in a reaction tank, and carbonation gas is injected to the tank under pressure by the pressurizing tank. In addition, the lithium hydroxide solution is strongly mixed with carbonation gas using a stirrer to cause lithium carbonate reaction. This method has a problem that a large volume of carbonation gas is used, a reaction time is long, and it needs a reaction vessel using high-pressure carbonation gas.

As a conventional technique for solving such a problem, there is a carbonation apparatus in which a pressurized tank is prepared, and then a lithium hydroxide aqueous solution is dropped into a pressurized vessel in a droplet state to perform a reaction. However, even if a pressurized tank is used, the droplet jetting method causes instantaneous negative pressure by consuming carbonation gas in the tank after ejection of the droplet immediately, and therefore requires a facility for maintaining a carbonation gas pressure with a very precise pressure means.

Further, since the process of reacting the injected lithium hydroxide aqueous solution with carbonation gas is in a pressurized state, excess carbonation gas is dissolved. As a result, the pH of the aqueous solution of lithium hydroxide is changed rapidly from the basic state to the neutral state due to the unreacted excess carbonation gas. During the pH lowering process, the excess carbonic group causes a carbonate reaction, which results in the problem that the lithium carbonate produced is re-dissolving into an aqueous solution of lithium hydroxide.

The re-dissolution problem of lithium carbonate can be prevented by precisely adjusting the pH. However, it is not easy to control the reaction of the carbonation gas dissolved in the aqueous solution of lithium hydroxide. If the additional reactant is added for controlling the pH, unwanted reaction byproducts are generated, and an additional step for removing the reaction byproduct. It is very difficult to effectively control the re-dissolving reaction, which results in a problem of lowering the production yield of lithium carbonate.

### DISCLOSURE

### Technical Problem

It is provided that a method and apparatus for producing carbonate by discharging (or spraying) carbonation gas (ex, carbon dioxide gas) into a discharging path of a solution to be carbonated to form a mist and instantly reacting a solution to be carbonated with a carbonation gas in the mist.

It is provided a lithium carbonate powder produced from a lithium hydroxide droplet containing carbonation gas (ex, carbon dioxide gas).

### Technical Solution

An apparatus for preparing carbonate according to an embodiment of the present invention includes a reactor in which carbonation gas reacts with a solution to be carbonated; a first nozzle located at one side of the reactor, and discharging the solution to be carbonated into the reactor, a second nozzle located adjacent to the first nozzle, and spraying the carbonation gas into the path through which the solution to be carbonated is discharged to form a mist composed of the solution to be carbonated and the carbonation gas, and a recovery unit located at a lower end of the reactor, and recovering a carbonate salt from the slurry formed in the reactor.

The recovery unit may include a filtration unit for filtering the carbonate salt from the slurry.

The recovery unit may include a drying unit for drying the filtered carbonate salt.

The recovery unit may include a plurality of filtration units, a drawout unit connecting the reactor and the plurality of filtration units, and a valve installed in a flow path connecting the draw-out unit and each of the filtration units.

The recovery unit may include a control unit connected to the valve, and the control unit may control the valve to control the throughput of the plurality of filtration units.

A carbonation gas circulating unit for recovering the carbonation gas discharged from the second nozzle and recirculating the carbonation gas to the second nozzle may be further included.

A solution to be carbonated circulating unit for recovering the solution to be carbonated from the slurry from which is filtered the carbonate salt, and recirculating the solution to be carbonated to the first nozzle may be further included.

The second nozzle may be a plurality.

The first nozzle and the second nozzle may form an angle of 10 DEG to 70 DEG in a vertical direction of a flow direction of the solution to be carbonated.

The first nozzle and the second nozzle may form an angle of 30 DEG to 50 DEG in a vertical direction of a flow direction of the solution to be carbonated.

The first nozzle may be located on the upper side of the reactor, and the second nozzle may be installed below the first nozzle.

The second nozzle may discharge the carbonation gas at a pressure of 1.5 bar to 2.5 bar.

The second nozzle may be installed for discharging the carbonation gas to a pass through which is away from a center portion of the solution to be carbonated to be discharged, on a perpendicular plane of a direction in which the solution to be carbonated is discharged.

A method for preparing carbonate according to an embodiment of the present invention includes: discharging a solution to be carbonated from a first nozzle; forming a mist composed of the solution to be carbonated and a carbonated gas by discharging a carbonation gas from a second nozzle to a path through which the solution to be carbonated is discharged; forming a slurry having carbonate by reacting a cation of the solution to be carbonated with the carbonation gas in the mist; and recovering the carbonate from the slurry.

The solution to be carbonated may include a calcium ion, a magnesium ion or a lithium ion as a cation.

A pH of the solution to be carbonated may be pH 10 or more.

The discharge path of the solution to be carbonated and the discharge path of the carbonation gas may form an angle of 10° to 70° in the vertical direction to the flow direction of the solution to be carbonated.

The discharge path of the solution to be carbonated and the discharge path of the carbonation gas may form an angle of 30° to 50° in the vertical direction to the flow direction of the solution to be carbonated.

The carbonation gas may be discharged in a direction away from a central portion of the solution to be carbonation to be discharged on a perpendicular plane of a direction in which the solution to be carbonated is discharged.

A droplet size of the solution to be carbonated in the mist may be 10 nm to 50 μm.

The carbonation gas may be discharged from the second nozzle at a pressure of 1.5 bar to 2 bar.

The step of recovering the carbonate may include filtering the solution to be carbonated containing the carbonate to recover the carbonate.

The step of recovering the carbonate may include drying the filtered carbonate.

A lithium carbonate powder according to an embodiment of the present invention may be prepared from a lithium hydroxide droplet containing carbonation gas.

The lithium carbonate powder may have a size of 2 μm to 20 μm.

The lithium hydroxide droplet may have a size of 10 nm to 50 μm.

### Effect

The solution to be carbonated and the carbonation gas can react immediately, and no additional reaction or side reaction occurs. In the reaction between the solution to be carbonated and the carbonation gas, only water (H₂O) is generated besides the carbonation salt, and side reactions do not occur besides carbonation reaction.

Since the pH of the solution to be carbonated before/after the solution to be carbonated and the carbonation gas are reacted with each other is maintained almost constant, the produced carbonation salts will not re-dissolve into the solution to be carbonated after the reaction.

This serves as a technical advantage in the actual process, which makes it possible to maintain the quality of the carbonation salts, regardless of the flow of time. As a result, the process management can be very easy and simple.

In addition, even when the unreacted cations remaining in the filtrate are re-reacted, there is no change in pH, so that the re-reaction can be repeated several times until a desired level of recovery yield is obtained.

In addition, the entire reaction process is performed at normal pressure and at room temperature, so that the reactor can be constructed simply.

The carbonation reaction occurs in mist, thus the nozzle is not clogged by the produced carbonate.

Continuous discharging and reaction processes are possible, thus the yield can be improved.

### BRIEF DESCRIPTION OF DRAWINGS

FIG. 1 is a schematic view showing an apparatus for producing carbonate according to an embodiment of the present invention.

FIG. 2 is a schematic view showing a first nozzle and a second nozzle of an apparatus for producing carbonate according to an embodiment of the present invention.

FIG. 3 is a schematic top view of an apparatus for producing carbonate according to one embodiment of the present invention.

FIG. 4 is a schematic view showing a state in which a solution to be carbonated is discharged in the apparatus for producing carbonate of FIG. 1.

FIG. 5 is a schematic view showing a state in which carbonation gas is discharged into a mist state in the apparatus for producing carbonate of FIG. 1, and an enlarged view showing a collision of droplets of a solution to be carbonated and carbonation gas.

FIG. 6 is a schematic flow chart of a method for producing carbonate according to an embodiment of the present invention.

FIG. 7 shows the XRD analysis results of the carbonate prepared by the manufacturing method of FIG. 6.

### DETAILED DESCRIPTION OF THE INVENTION

The terminology used herein is for the purpose of describing particular embodiments only and is not intended to be limiting of the invention.

The singular forms used herein include plural forms as well, provided that the phrases do not expressly have the opposite meaning. As used herein, the term “comprise” means that a particular feature, region, integer, step, operation, element and/or component may be specified. In addition, an existence or the addition of other specific feature, region, integer, step, operation, element, component, and/or group may not be excluded.

Unless defined otherwise, all terms including technical and scientific terms used herein have the same meaning as commonly understood by one of ordinary skill in the art to which this invention belongs.

Commonly used predefined terms are further interpreted as having a meaning consistent with the relevant technical literature and the present disclosure, and are not to be construed as ideal or very formal meanings unless defined otherwise.

Hereinafter, embodiments of the present invention will be described in detail. However, it should be understood that the present invention is not limited thereto, and the present invention is only defined by the scope of the following claims.

An apparatus for preparing carbonate according to an embodiment of the present invention includes a reactor (50) in which carbonation gas (70) reacts with a solution to be carbonated (60); a first nozzle (10) located at one side of the reactor (50), and discharging the solution to be carbonated (60) into the reactor (50), a second nozzle (20) located adjacent to the first nozzle (10), and spraying the carbonation gas (70) into the path through which the solution to be carbonated (60) is discharged to form a mist composed of the solution to be carbonated (60) and the carbonation gas (70), and a recovery unit (30) located at a lower end of the reactor (50), and recovering a carbonate salt (80) from the slurry formed in the reactor (50). In addition, if desired, the apparatus for preparing carbonate may further include other configurations.

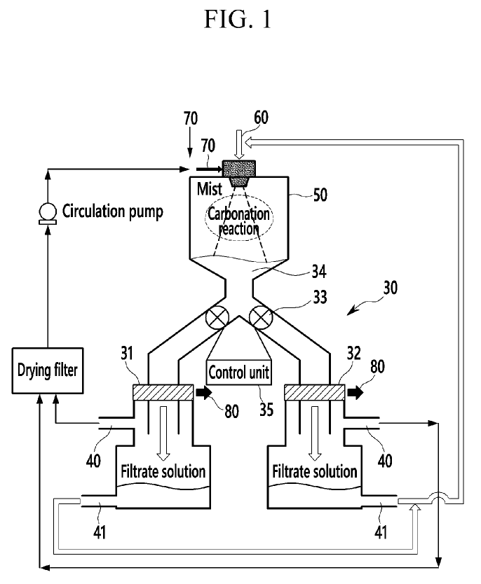

FIG. 1 schematically shows an apparatus for producing carbonate according to an embodiment of the present invention. The apparatus for producing carbonate of FIG. 1 is merely for illustrating the present invention, and the present invention is not limited thereto. Therefore, the apparatus for producing carbonate can be variously modified.

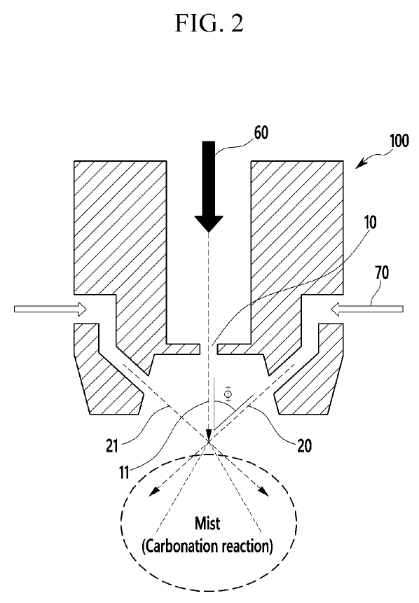

FIG. 1 shows a schematic view of an apparatus for producing a whole carbonate, and FIG. 2 schematically shows a first nozzle and a second nozzle of a device for producing carbonate.

Referring to FIGS. 1 and 2, in the reactor (50), the solution to be carbonated (60) reacts with the carbonation gas (70).

A nozzle unit (100) for discharging the solution to be carbonated (60) and the carbonation gas (70) into the reactor (50) is disposed at one side of the reactor (50). The nozzle unit (100) includes a first nozzle (10) discharging the solution to be carbonated (60) into the reactor (50), a second nozzle (20) spraying the carbonation gas (70) into the path through which the solution to be carbonated (60) is discharged.

A first nozzle (10) for discharging a solution to be carbonated into the reactor (50) is installed at one side of the reactor (50). A second nozzle (20) is provided at a position adjacent to the first nozzle (10). A carbonation acid gas (70) is sprayed from the second nozzle (20) to the path through which the solution to be carbonated (60) is discharged from the first nozzle (10) to form a mist composed of the solution to be carbonated (60) and the carbonation gas (70), and the carbonate (80) is produced by reacting the solution to be carbonated (60) and the carbonation gas (70) in the mist.

At the lower end of the reactor (50), a recovery unit (30) for recovering the carbonate (80) from the slurry formed in the reactor (50) is provided.

The recovery unit (30) includes filtration unit (31, 32) for filtering the carbonate from the slurry and may include a drying unit for drying the filtered carbonate. The recovery unit (30) may include a draw-out unit (34) connecting the reactor (50) and the filtration units (31, 32).

The filtration unit (31, 32) may be composed of a plurality of filtration units (31, 32), although the two filtration units (31, 32) are shown in FIG. 1 for the sake of convenience. In case of that a plurality of filtration units (31, 32) are used, a valve (33) may be installed in the flow path connecting the draw-out unit (34) and each of the filtration units (31, 32).

The plurality of valves (33) provided in the respective flow paths are controlled by a control unit (35) connected to the valves, so that the throughput of the plurality of filtration units (31, 32) can be controlled. The control unit controls the opening and locking of the plurality of valves (33) so that the slurry can be alternately filtered through the plurality of filtration units (31, 32). For example, if the first filtration unit (31) is filtrated with a certain amount of carbonate (80) relative to the total throughput, the filtration efficiency is lowered. Accordingly, the valve (33) installed in the flow path connected to the first filtration unit (31) is closed through the control unit and the valve (33) provided in the flow path connected to the second filtration unit (32) is opened to supply the slurry to the second filtration unit (32), so as to control the throughputs of the first filtration unit and the second filtration unit.

The first filtration unit (31) and the second filtration unit (32) are operated repeatedly and alternatively in such a manner that the filtration filter of the first filtration unit (31) is replaced while the slurry containing the carbonate is filtered by the second filtration unit (32), so that the filtration process can be continuously performed.

When the throughput of one of the plurality of filtration units (31, 32) reaches 80% or more of the total throughput of the filtration unit, the control unit locks the valve connected to the filtration unit, and opens the valve connected to the other filtration unit. It is possible to control the throughput of the plurality of filtration units (31, 32) by operating the filtration units (31, 32) alternately.

In FIG. 1, the apparatus for producing carbonate may further include a carbonation gas circulating unit (40). The carbonation gas circulating unit (40) recovers the carbonation gas (70) injected from the second nozzle (20), and then the carbonation gas recovered may be dried through the drying filter. Finally, the carbonation gas re-circulated back to the second nozzle (20) together with the new carbonation gas. The carbonation gas (70) can be efficiently used by reusing the carbonation gas (70) through the carbonation gas circulating unit (40).

The apparatus for producing carbonate may further include a solution to be carbonated circulating unit (41). The solution to be carbonated circulating unit (41) recovers the solution to be carbonated (60) from the slurry in which the carbonate (80) is filtered, and then recycle the same to the first nozzle (10). There is an advantage that the solution to be carbonated (60) can be efficiently used by reusing the solution to be carbonated (60) through the solution to be carbonated circulating unit (41) and almost no solution to be carbonated (60) is discarded.

Hereinafter, the first nozzle (10) and the second nozzle (20) will be described in more detail with reference to FIG. 2.

As shown in FIG. 2, a plurality of second nozzles 20 may be provided. In addition, the first nozzle (10) and the second nozzle (20) can form an angle of 10 DEG to 70 DEG n a vertical direction of a flow direction of the solution to be carbonated (60). When the angle is less than 10 DEG, the carbonate (80) is produced at the inlet of the first nozzle (10) or the second nozzle (20), and the problem of clogging the inlet of the first nozzle (10) or the second nozzle (20) may occur. If the angle is 70 DEG or more, the area where the solution to be discharged (60) and the carbonation gas (70) collide with each other becomes narrow, and the reaction between the solution to be carbonated (60) and the carbonation gas (70) may not be smoothly performed. More specifically, the first nozzle (10) and the second nozzle (20) may form an angle of 30 DEG to 50 DEG in a vertical direction of a flow direction of the solution to be carbonated.

The first nozzle (10) may be installed on the upper side of the reactor (50) and the first nozzle (10) may be installed on the upper side of the second nozzle (20). Specifically, it is preferable that the second nozzle (20) is installed at a position 3 mm to 20 mm below the first nozzle (10). The distance between the first nozzle (10) and the second nozzle (20) can be determined in proportion to the amount of the solution to be carbonated (60) discharged from the first nozzle (10). For example, the amount of the solution to be carbonated (60) discharged from the first nozzle (10) may be 100 ml/min to 5,000 ml/min, and the distance of the first nozzle (10) and the second nozzle (20) can be adjusted in the range of 3 mm to 20 mm according to the amount of the solution to be carbonated (60). When the amount of the solution to be carbonated (60) discharged from the first nozzle (10) exceeds 5000 ml/min, the second nozzle (20) can be additionally provided.

The carbonation gas (70) is discharged from the second nozzle (20) into the path through (11) which the solution to be carbonated (60) is discharged so that the carbonation gas (70) immediately reacts with the solution to be carbonated (60) and pulverizes the solution to be carbonated into a mist state.

The pressure of the carbonation gas (70) discharged from the second nozzle (20) may be 1.5 bar to 2.5 bar.

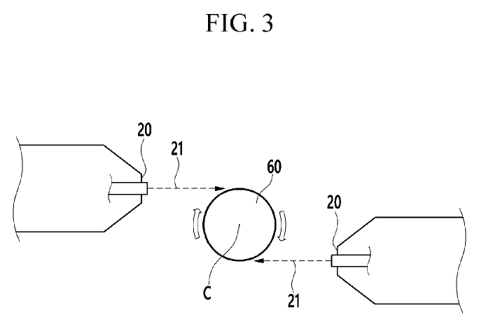

As shown in FIG. 3, the second nozzle (20) may be installed for discharging the carbonation gas to a pass through which is away from a center portion (c) of the solution to be carbonated (60) to be discharged, on a perpendicular plane of a direction in which the solution to be carbonated (60) is discharged. When a plurality of the second nozzles (20) is provided, the plurality of second nozzles (20) is arranged in a direction away to right side (or left side) from the center portion of the solution to be carbonated (60) to be discharged. The solution to be carbonated (60) is crushed and twisted in the counterclockwise (or clockwise) direction so that the mist can be formed. In FIG. 3, thereby showing an example in which the solution to be carbonated (60) is rotated and misted in the counterclockwise direction by providing two second nozzles (20) so as to discharge the carbonation gas to the right from the center of the solution to be carbonated (60).

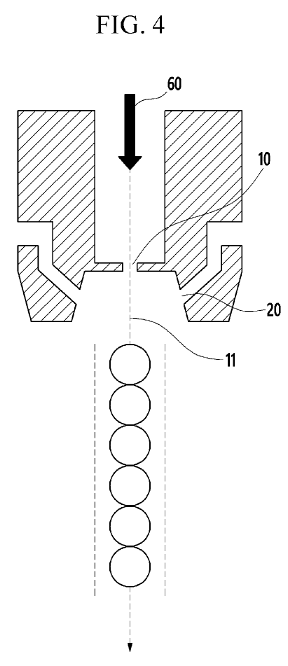

FIG. 4 schematically shows the shape of the solution to be carbonated (60) discharged from the first nozzle (10).

The discharged solution to be carbonated (60) can flow out from the first nozzle (10) with a constant flow. Specifically, the solution to be carbonated (60) leaving the first nozzle (10) can be configured to have a flow similar to the free flow in the gravitational field.

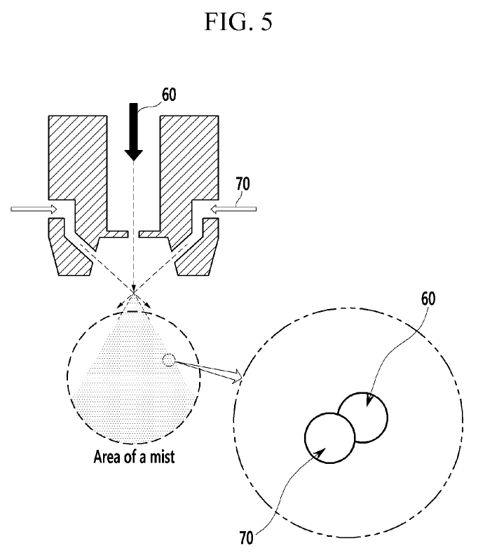

FIG. 5 schematically shows a state in which carbonation gas (70) is discharged from the second nozzle (20) and the solution to be carbonated (60) is in a mist state, and the collision of the droplets of the solution to be carbonated (60) with the carbonation gas (70).

The droplet size of the solution to be carbonated (60) in the mist state can be 10 nm to 50 μm. If the droplet size is too small, the surface area of the droplet becomes large and the carbonation gas (70) may be over-soluble in the solution to be carbonated (60). If the droplet size is too large, the surface area of the droplet becomes small; the carbonation gas (70) may not be sufficiently dissolved in the solution to be carbonated (60).

The discharged carbonation gas (70) is instantaneously dissolved in the solution to be carbonated (60) which is a strong base and reacts with cations in the solution to be carbonated (60) to be converted into the carbonate (80). For example, when the solution to be carbonated (60) is an aqueous solution of lithium hydroxide and the carbonation gas (70) is carbon dioxide gas, the reaction formula can be expressed as follows.

2Li⁺+2OH⁻+CO₂(aq)+H₂O→2Li⁺+2OH⁻+H₂CO₃(aq)→

2Li⁺+2OH⁻+H⁺+HCO₃⁻→2Li⁺+OH⁻+HCO₃⁻+H₂O→

2Li⁺+CO₃²⁻+2H₂O→Li₂CO₃↓+2H₂O

As shown in the above reaction formula, in the reaction of the solution to be carbonated (60) with the carbonation gas (70), only water (H₂O) is generated besides the carbonate (80), and side reactions other than the carbonate reaction do not occur.

As a result, since the pH of the solution to be carbonated (60) before/after the solution to be carbonated (60) and the carbonation gas (70) are reacted with each other is maintained almost constant, the produced carbonation salts (carbonate) will not re-dissolve into the solution to be carbonated (60) after the reaction. This serves as a technical advantage in the actual process, which makes it possible to maintain the quality of the carbonation salts, regardless of the flow of time. As a result, the process management can be very easy and simple. In addition, even when the unreacted cations remaining in the filtrate are re-reacted, there is no change in pH, so that the re-reaction can be repeated several times until a desired level of recovery yield is obtained. In addition, the entire reaction process is performed at normal pressure and at room temperature, so that the reactor (50) can be constructed simply.

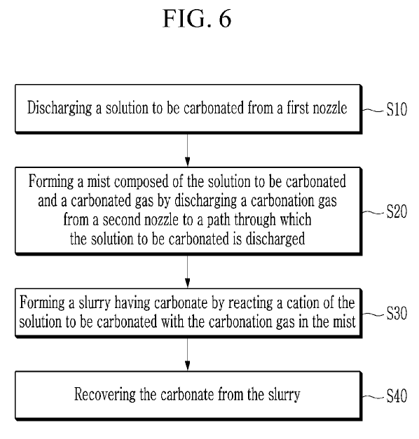

FIG. 6 schematically shows a flow chart of a process for producing carbonates according to one embodiment of the present invention. The flowchart of the carbonate production process of FIG. 6 is only for illustrating the present invention and the present invention is not limited thereto. Therefore, the method of manufacturing the carbonate can be variously modified.

As shown in FIG. 6, a method for preparing carbonate according to an embodiment of the present invention includes: discharging a solution to be carbonated from a first nozzle (S10); forming a mist composed of the solution to be carbonated and a carbonated gas by discharging a carbonation gas from a second nozzle to a path through which the solution to be carbonated is discharged (S20); forming a slurry having carbonate by reacting a cation of the solution to be carbonated with the carbonation gas in the mist (S30); and recovering the carbonate from the slurry (S40). In addition, the method for manufacturing carbonate may further include other steps as needed.

First, in step S10, a solution to be carbonated from the first nozzle is discharged. The solution to be carbonated can be used without particular limitation as long as it is a substance that reacts with carbonation gas to cause carbonation reaction. Specifically, the solution to be carbonated may include a calcium ion, a magnesium ion, or a lithium ion as a cation. More specifically, the solution to be carbonated may be an aqueous solution of lithium hydroxide.

The pH of the solution to be carbonated may be above pH 10. If the pH of the solution to be carbonated is too low, the produced carbonate may be re-dissolved in the solution to be carbonated.

The discharged solution to be discharged can be flowed out from the first nozzle with a constant flow. Specifically, the solution to be carbonated leaving the first nozzle can be configured to have a flow similar to the free flow in the gravitational field.

FIG. 2 schematically shows the shape of the solution to be carbonated discharged from the first nozzle.

In step S20, the carbonation gas is discharged from the second nozzle into the path through which the solution to be carbonated is discharged to form a mist composed of the solution to be carbonated and the carbonation gas.

The discharge path of the solution to be carbonated and the discharge path of the carbonation gas can form an angle of 10 DEG to 70 DEG in the vertical direction of the flow direction of the solution to be carbonated. If the angle is too small, carbonate may be produced at the inlet of the first nozzle or the second nozzle, thereby blocking the inlet of the first nozzle or the second nozzle. If the angle is too large, the area of collision between the solution to be carbonated and the carbonation gas becomes narrow, so that the reaction between the solution to be carbonated and the carbonation gas may not be smoothly performed. More specifically, the discharge path of the solution to be carbonated and the discharge path of the carbonation gas may form an angle of 30° to 50° in the vertical direction to the flow direction of the solution to be carbonated.

The carbonation gas is discharged from the second nozzle into the path through which the solution to be carbonated is discharged to form a mist composed of the solution to be carbonated and the carbonation gas.

As shown in FIG. 3, the carbonation gas is discharged to a pass through which is away from a center portion (c) of the solution to be carbonated to be discharged, on a perpendicular plane of a direction in which the solution to be carbonated is discharged. When a plurality of the second nozzles is provided, the carbonation gas is discharged in a direction away to right side (or left side) from the center portion of the solution to be carbonated to be discharged. The solution to be carbonated is crushed and twisted in the counterclockwise (or clockwise) direction so that the mist can be formed. In FIG. 3, thereby showing an example in which the solution to be carbonated is rotated and misted in the counterclockwise direction by providing two second nozzles so as to discharge the carbonation gas to the right from the center of the solution to be carbonated.

The droplet size of the solution to be carbonated (60) in the mist state can be 10 nm to 50 μm. If the droplet size is too small, the surface area of the droplet becomes large and the carbonation gas may be over-soluble in the solution to be carbonated. If the droplet size is too large, the surface area of the droplet becomes small; the carbonation gas may not be sufficiently dissolved in the solution to be carbonated.

The pressure of the carbonation gas to be discharged can be adjusted from 1.5 bar to 2.5 bar to make the droplet size of the solution to be carbonated.

The discharged carbonation gas is instantaneously dissolved in the solution to be carbonated which is a strong base and reacts with lithium hydroxide in the solution to be carbonated to be converted into the carbonate. For example, when the solution to be carbonated is an aqueous solution of lithium hydroxide and the carbonation gas is carbon dioxide gas, the reaction formula can be expressed as follows.

2Li⁺+2OH⁻+CO₂(aq)+H₂O→2Li⁺+2OH⁻+H₂CO₃(aq)→

2Li⁺+2OH⁻+H⁺+HCO₃⁻→2Li⁺+OH⁻+HCO₃⁻+H₂O→

2Li⁺+CO₃²⁻+2H₂O→Li₂CO₃↓+2H₂O

As shown in the above reaction formula, in the reaction of the solution to be carbonated with the carbonation gas, only water (H₂O) is generated besides the carbonate and side reactions other than the carbonate reaction do not occur.

As a result, since the pH of the solution to be carbonated before/after the solution to be carbonated and the carbonation gas are reacted with each other is maintained almost constant, the produced carbonation salts (carbonate) will not re-dissolve into the solution to be carbonated after the reaction. This serves as a technical advantage in the actual process, which makes it possible to maintain the quality of the carbonation salts, regardless of the flow of time. As a result, the process management can be very easy and simple. In addition, even when the unreacted lithium ion remaining in the filtrate are re-reacted, there is no change in pH, so that the re-reaction can be repeated several times until a desired level of recovery yield is obtained. In addition, the entire reaction process is performed at normal pressure and at room temperature, so that the reactor (50) can be constructed simply.

FIG. 2 is a schematic view showing a state in which carbonation gas is discharged from the second nozzle and the solution to be carbonated is changed into a mist state. In addition, FIG. 2 is an enlarged view of a contact state of a carbonation gas and a droplet of a solution to be carbonated in a mist state.

In step S30, the cation of the solution to be carbonated reacts with the carbonation gas in the mist to form a slurry containing carbonate. The carbonate produced is contained in the slurry in a solid state.

In step S40, the carbonate is recovered from the slurry. The carbonate can be recovered by filtering the slurry. The filtered carbonate may be dried to obtain a high-purity carbonate powder.

The lithium carbonate according to one embodiment of the present invention is produced from a lithium hydroxide droplet containing a carbonation gas.

The prepared lithium carbonate is in powder form and may have a size of 2 μm to 20 μm. More specifically, the powder size of lithium carbonate may be 4 μm to 8 μm, and the size of the lithium droplets may be 10 nm to 50 μm.

Hereinafter, preferred embodiments and comparative examples of the present invention will be described. However, the following examples are merely preferred embodiments of the present invention, and the present invention is not limited to the following examples.

### EXAMPLE

As the solution to be carbonated, a lithium hydroxide aqueous solution was used, and carbon dioxide gas was used as carbonation gas. The lithium hydroxide aqueous solution was discharged into the reactor through the first nozzle and the carbon dioxide gas was discharged from the second nozzle to react the aqueous lithium hydroxide solution and the carbonated gas. The angle between the discharge path of the first nozzle and the discharge path of the second nozzle was adjusted to be 50 degrees in the vertical direction of the flow direction of the solution to be carbonated and the pressure of the carbonation gas discharged from the second nozzle was adjusted to 2 bar. The reactor was maintained at normal pressure and room temperature.

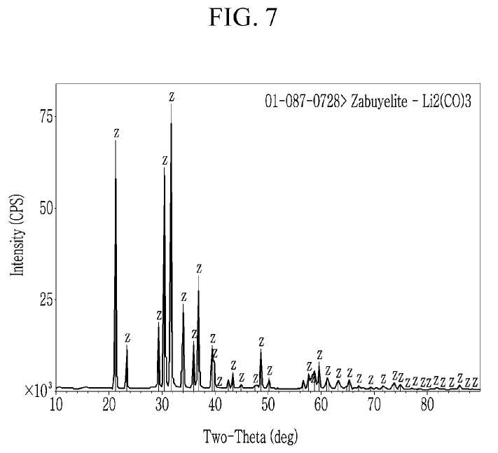

The lithium hydroxide aqueous solution reacted with the carbonation gas was filtered to obtain lithium carbonate, which was dried to finally obtain lithium carbonate in powder form. This was analyzed by XRD and is shown in FIG. 7.

The lithium hydroxide aqueous solution was recovered in the lithium carbonate-filtered slurry and the same procedure was repeated.

The concentration of lithium in the aqueous solution of lithium hydroxide before the reaction, the concentration of lithium in the aqueous solution of lithium hydroxide after the first reaction and the concentration of lithium in the aqueous solution of lithium hydroxide after the second reaction are summarized in Table 1 below.

TABLE 1

| | Before | After the first | after the second |
|---|---|---|---|
| | reaction | reaction | reaction |
| Lithium hydroxide | 30520 | 7642 | 4748 |
| concentration (mg/L) | (100 wt %) | (25.03 wt %) | (15.55 wt %) |
| | | 74.96 wt % | 84.44 wt % |
| | | reaction | reaction |

As shown in Table 1, it was confirmed that lithium carbonate was obtained at a high yield of 84 wt % or more through two successive reactions.

It will be understood by those skilled in the art that various changes in form and details may be made therein without departing from the spirit and scope of the present invention as defined by the following claims. It is therefore to be understood that the above-described embodiments are illustrative in all aspects and not restrictive.

### DESCRIPTION OF SYMBOL

10: first nozzle
11: path through which the solution to be carbonated is discharged
20: second nozzle
21: path through which the carbonation gas is discharged
30: recovery unit
31, 32: filtration unit
33: valve
34: draw-out unit
35: control unit
40: carbonation gas circulating unit
41: solution to be carbonated circulating unit
50: reactor
60: solution to be carbonated
70: carbonation gas
80: carbonate (carbonate salt)
100: nozzle unit

1. An apparatus for preparing carbonate comprising:
a reactor in which carbonation gas reacts with a solution to be carbonated;
a first nozzle located at one side of the reactor, and discharging the solution to be carbonated into the reactor,
a second nozzle located adjacent to the first nozzle, and spraying the carbonation gas into the path through which the solution to be carbonated is discharged to form a mist composed of the solution to be carbonated and the carbonation gas, and
a recovery unit located at a lower end of the reactor, and recovering a carbonate salt from the slurry formed in the reactor.

2. The apparatus for preparing carbonate of claim 1,
wherein the recovery unit comprises a filtration unit for filtering the carbonate salt from the slurry.

3. The apparatus for preparing carbonate of claim 2,
wherein the recovery unit comprises a drying unit for drying the filtered carbonate salt.

4. The apparatus for preparing carbonate of claim 2,
wherein the recovery unit comprises a plurality of filtration units,
wherein the recovery unit comprises a draw-out unit connecting the reactor and the plurality of filtration units, and a valve installed in a flow path connecting the draw-out unit and each of the filtration units.

5. The apparatus for preparing carbonate of claim 4,
wherein the recovery unit comprises a control unit connected to the valve,
wherein the control unit controls the valve to control the throughput of the plurality of filtration units.

6. The apparatus for preparing carbonate of claim 1, comprising:
a carbonation gas circulating unit for recovering the carbonation gas discharged from the second nozzle and recirculating the carbonation gas to the second nozzle.

7. The apparatus for preparing carbonate of claim 1, comprising:
a solution to be carbonated circulating unit for recovering the solution to be carbonated from the slurry from which is filtered the carbonate salt, and recirculating the solution to be carbonated to the first nozzle.

8. The apparatus for preparing carbonate of claim 1,
wherein the second nozzle is a plurality.

9. The apparatus for preparing carbonate of claim 1,
wherein the first nozzle and the second nozzle form an angle of 10 DEG to 70 DEG in a vertical direction of a flow direction of the solution to be carbonated.

10. The apparatus for preparing carbonate of claim 9,
wherein the first nozzle and the second nozzle form an angle of 30 DEG to 50 DEG in a vertical direction of a flow direction of the solution to be carbonated.

11. The apparatus for preparing carbonate of claim 1,
wherein the first nozzle is located on the upper side of the reactor, and the second nozzle is installed below the first nozzle.

12. The apparatus for preparing carbonate of claim 1,
wherein the second nozzle discharges the carbonation gas at a pressure of 1.5 bar to 2.5 bar.

13. The apparatus for preparing carbonate of claim 1,
wherein, the second nozzle is installed for discharging the carbonation gas to a pass through which is away from a center portion of the solution to be carbonated to be discharged, on a perpendicular plane of a direction in which the solution to be carbonated is discharged.

14. A method for preparing carbonate, comprising:
discharging a solution to be carbonated from a first nozzle;
forming a mist composed of the solution to be carbonated and a carbonated gas by discharging a carbonation gas from a second nozzle to a path through which the solution to be carbonated is discharged;
forming a slurry having carbonate by reacting a cation of the solution to be carbonated with the carbonation gas in the mist; and
recovering the carbonate from the slurry.

15. The method for preparing carbonate of claim 14,
wherein, the solution to be carbonated comprises a calcium ion, a magnesium ion or a lithium ion as a cation.

16. The method for preparing carbonate of claim 14, wherein a pH of the solution to be carbonated is pH 10 or more.

17. The method for preparing carbonate of claim 14,
wherein, the discharge path of the solution to be carbonated and the discharge path of the carbonation gas form an angle of 10° to 70° in the vertical direction to the flow direction of the solution to be carbonated.

18. The method for preparing carbonate of claim 17,
wherein, the discharge path of the solution to be carbonated and the discharge path of the carbonation gas form an angle of 30° to 50° in the vertical direction to the flow direction of the solution to be carbonated.

19. The method for preparing carbonate of claim 14,
wherein, the carbonation gas is discharged in a direction away from a central portion of the solution to be carbonation to be discharged on a perpendicular plane of a direction in which the solution to be carbonated is discharged.

20. The method for preparing carbonate of claim 14,
wherein, a droplet size of the solution to be carbonated in the mist is 10 nm to 50 μm.

21. The method for preparing carbonate of claim 14,
wherein, the carbonation gas is discharged from the second nozzle at a pressure of 1.5 bar to 2 bar.

22. The method for preparing carbonate of claim 14,
wherein, the step of recovering the carbonate comprises filtering the solution to be carbonated containing the carbonate to recover the carbonate.

23. The method for preparing carbonate of claim 22,
wherein, the step of recovering the carbonate comprises drying the filtered carbonate.

24. (canceled)

25. (canceled)

26. (canceled)
